(19) United States
(12) Patent Application Publication
(10) Pub. No.: US 2026/0303256 A1
(43) Pub. Date: Oct. 1, 2026

(54) DYNAMIC FORWARD ERROR CORRECTION (FEC) OPTIMIZATION

(71) Applicant: Mellanox Technologies, Ltd., Yokneam (IL)

(72) Inventors: Alok Kumar, Bangalore (IN); Michael Franklin Brown, Fuquay Varina, NC (US)

(21) Appl. No.: 19/091,585

(22) Filed: Mar. 26, 2025

(51) Int. Cl. H04L 1/00

(52) U.S. Cl. CPC H04L 1/0045

(57) ABSTRACT

Technologies for dynamic Forward Error Correction (FEC) optimization are described. A first communication device encodes first data using an FEC encoder at a first encoding rate. The first communication device sends the first data to a second communication device over a link between the first communication device and the second communication device. The first communication device obtains a bit error rate (BER) measurement and a signal-to-noise ratio (SNR) measurement associated with the link. The first communication device determines a second encoding rate using the BER measurement and the SNR measurement. The first communication device encodes second data using the FEC encoder at the second encoding rate. The first communication device sends the second data to the second communication device over the link.

### TECHNICAL FIELD

At least one embodiment pertains to processing resources used to dynamically adjust FEC settings based on bit error rate (BER) and signal-to-noise ratio (SNR). For example, at least one embodiment pertains to a communication device with a transmitter, an FEC encoder, and FEC control logic to dynamic adjust FEC settings based on BER and SNR.

### BACKGROUND

The evolution of digital communication networks has seen a significant increase in the demand for high data integrity and reliable transmission, especially in environments prone to noise and signal degradation. Forward Error Correction (FEC) is a technique used in digital communication to improve data transmission reliability between two devices. It allows the receiving device to detect and correct errors without needing retransmission, which is crucial in high-speed and long-distance communication. FEC has been a cornerstone in achieving this reliability by introducing redundancy into the transmitted data, allowing the receiver to detect and correct errors without the need for retransmission. FEC works by enhancing communication reliability through error detection and correction at different stages of data transmission. At the sender's end, the transmitting device—such as a computer, router, or modem—applies an FEC algorithm to the data before sending it. This process involves adding redundant error correction bits, known as parity or check bits, using mathematical techniques such as Hamming codes, Reed-Solomon codes, or Low-Density Parity-Check (LDPC) codes. These additional bits allow the receiver to identify and fix errors without needing retransmission.

Once encoded, the data is transmitted over a communication channel, which may include wired links, fiber optic links, wireless networks, satellite communication, radio frequency (RF) communication, or the like. During transmission, the data is susceptible to various issues such as noise, interference, or packet loss, which can introduce bit errors. Despite these challenges, the added redundancy helps ensure data integrity.

At the receiving end, the device—whether a computer, server, or router—uses the same FEC algorithm to process the incoming data. It examines the redundant bits to detect and correct errors, eliminating the need for retransmission. However, if the number of errors exceeds the FEC's correction capability, additional error detection mechanisms like Cyclic Redundancy Check (CRC) may identify the data as corrupted. By implementing this approach, FEC significantly improves data transmission reliability, particularly in environments where retransmissions would be costly or impractical.

### BRIEF DESCRIPTION OF DRAWINGS

Various embodiments in accordance with the present disclosure will be described with reference to the drawings, in which:

FIG. 1 is a block diagram of a computing system with a network device with a Forward Error Correction (FEC) control logic according to at least one embodiment.

FIG. 2 is a block diagram of a network device with FEC control logic according to at least one embodiment.

FIG. 3 is a block diagram of FEC control logic according to at least one embodiment.

FIG. 4 is a flow diagram of an example process flow for updating FEC setting of a link based on BER and SNR measurements according to at least one embodiment.

FIG. 5 is a flow diagram of an example method for dynamically adjusting FEC configuration based on BER and SNR measurements according to at least one embodiment.

FIG. 6A illustrates an example communication system with a controller with FEC control logic for dynamic FEC optimization according to at least one embodiment.

FIG. 6B illustrates a block diagram of an example communication system employing a transmitter with FEC control logic for dynamic FEC optimization according to at least one embodiment.

FIG. 7 illustrates an example computer system including FEC control logic according to at least one embodiment.

FIG. 8 is a block diagram of a computing system having two processing devices coupled to each other and multiple networks according to at least one embodiment.

FIG. 9 is a block diagram of a computing system having a central processing unit (CPU) and a graphics processing unit (GPU) in a single integrated circuit according to at least one embodiment.

FIG. 10 is a block diagram of a computing system having tensor core graphics processing units (GPUs) according to at least one embodiment.

### DETAILED DESCRIPTION

Technologies for dynamic FEC optimization are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

In modern network communications, FEC encoding enhances data integrity over noisy or unreliable links by adding error correction redundancy. As described above, FEC has been a cornerstone in achieving this reliability by introducing redundancy into the transmitted data, allowing the receiver to detect and correct errors without the need for retransmission. This method, however, has traditionally suffered from the limitations of static configuration, which fails to adapt to the dynamic nature of network conditions. Fixed FEC configurations can either overutilize bandwidth or fail to provide adequate error correction as network conditions fluctuate. Traditional methods for improving link stability, such as modulation changes and physical-layer FEC adjustments, often depend on hardware support and lack flexibility for real-time, software-based adjustments.

Aspects and embodiments of the present disclosure address these problems and others by providing an adaptive FEC control mechanism, e.g., at the network operating system (NOS) layer that dynamically adjusts FEC encoding rates based on bit error rate (BER) and signal-to-noise ratio (SNR) measurements, optimizing error correction strength and bandwidth usage in real time. BER and SNR are critical indicators of link quality. BER measures the number of bit errors in a transmitted data stream, while SNR assesses the ratio of the signal power to the noise power in a transmission. By continuously monitoring these parameters, the FEC control mechanism can dynamically adjust the level of FEC redundancy required to maintain data integrity. Rather than relying on machine learning models, which can introduce significant computational overhead, the FEC control mechanism utilizes a rule-based approach for decision-making. Predefined rules are established based on extensive empirical data, mapping specific BER and SNR values to corresponding FEC rates. This FEC control mechanism ensures quick and efficient adjustments with minimal computational load.

Aspects and embodiments of the present disclosure can be used for adaptive FEC control integrated at a Network Operating System (NOS) layer, which dynamically adjusts FEC encoding rates based on real-time measurements of BER and SNR. Aspects and embodiments of the present disclosure can use a rule-based approach, automatically increasing or decreasing FEC redundancy in response to link quality changes. The BER and SNR can represent an indication of link quality of a link between two devices. Aspects and embodiments of the present disclosure reduces computational complexity, enhance bandwidth efficiency, and maintain link stability without relying on complex processing solutions, such as machine learning algorithms. Aspects and embodiments of the present disclosure also ensures synchronized adjustments between communication endpoints, creating a robust, flexible method for error correction across diverse network conditions. Aspects and embodiments of the present disclosure dynamically adjusts FEC encoding rates based on BER and SNR measurements, optimizing error correction strength and bandwidth usage in real time.

Unlike traditional approaches using static FEC configurations that fail to adapt to the dynamic nature of network conditions, aspects and embodiments of the present disclosure can use adaptive FEC that alters the error correction parameters based on ongoing assessments of link quality. Aspects and embodiments of the present disclosure leverage real-time BER and SNR measurements to guide these adjustments within the NOS layer, providing a more responsive and efficient error correction mechanism. BER and SNR are strong indicators of link quality. BER measures the number of bit errors in a transmitted data stream, while SNR assesses the ratio of the signal power to the noise power in a transmission. By continuously monitoring these parameters, aspects and embodiments of the present disclosure can dynamically adjust the level of FEC redundancy required to maintain data integrity. Rather than relying on machine learning models or other complex computing solutions, which can introduce significant computational overhead, the aspects and embodiments of the present disclosure can utilize a rule-based approach for decision-making. Predefined rules can be established based on extensive empirical data, mapping specific BER and SNR values to corresponding FEC rates. This ensures quick and efficient adjustments with minimal computational load.

Aspects and embodiments of the present disclosure can have various advantages of the conventional approaches, including optimized bandwidth usage, optimized latency, reduced computational complexity, maintained link stability, flexibility across network conditions, and the like. With respect to optimized bandwidth usage and latency introduced by the FEC algorithm, by adapting FEC rates to current link conditions, aspects and embodiments of the present disclosure minimizes redundancy during stable periods and enhances error correction in unstable conditions, ensuring optimal use of available bandwidth and optimal latency. In particular, an FEC algorithm can introduce latency from transmission to reception due to the time required to transmit the overhead bytes and the encoding and decoding times. Different FEC algorithms introduce different latency depending on the algorithm and implementation on the transmitter and receiver devices. With respect to reduced computational complexity, the rule-based algorithm can minimize the computational resources required for real-time FEC adjustments, making it suitable for deployment in resource-constrained environments. Aspects and embodiments of the present disclosure can adjust FEC rates in response to varying BER and SNR to ensure stable and reliable communication even in fluctuating network conditions. Aspects and embodiments of the present disclosure can allow effective error correction across diverse network environments, including telecommunications, satellite communications, and industrial IoT networks. Aspects and embodiments of the present disclosure can be versatile and can be applied in various domains where maintaining data integrity and efficient bandwidth usage are critical, such as telecommunications, satellite communications, data center communications, industrial IoT, broadcast and media streaming, etc. Aspects and embodiments of the present disclosure can enhance the reliability of voice and data transmission over cellular networks by adapting to changing signal conditions. Aspects and embodiments of the present disclosure can address the unique challenges of long-distance signal transmission and varying atmospheric conditions for satellite communications. Aspects and embodiments of the present disclosure can ensure robust communication between IoT devices in industrial environments, where interference and signal degradation can be significant issues. Aspects and embodiments of the present disclosure can improve the quality and consistency of broadcast signals and streaming services by dynamically adjusting to real-time link quality.

Aspects and embodiments of the present disclosure can provide an efficient, responsive method for adaptive FEC control, using real-time BER and SNR measurements to manage error correction dynamically, such as at the NOS layer. By maintaining optimal FEC settings across fluctuating network conditions, aspects and embodiments of the present disclosure can balance bandwidth utilization and data integrity, supporting high-performance, resilient communication in diverse network applications. This adaptive FEC control approach offers a robust solution for enhancing network reliability and efficiency without the computational demands of machine learning, making it well-suited for both existing and next-generation communication networks.

Aspects and embodiments of the present disclosure can be used in any communication link. The communication link can be a Serializer-Deserializer (SerDes) link, an NVLink, cellular networking, PCIe, Ethernet, InfiniBand, Ground Reference Signal (GRS), Chip-to-Chip (C2C), Die-to-Die (D2D), LPI (low power interface) or LLI (low latency interface), or the like. Aspects and embodiments of the present disclosure can be used in various applications, including communication applications.

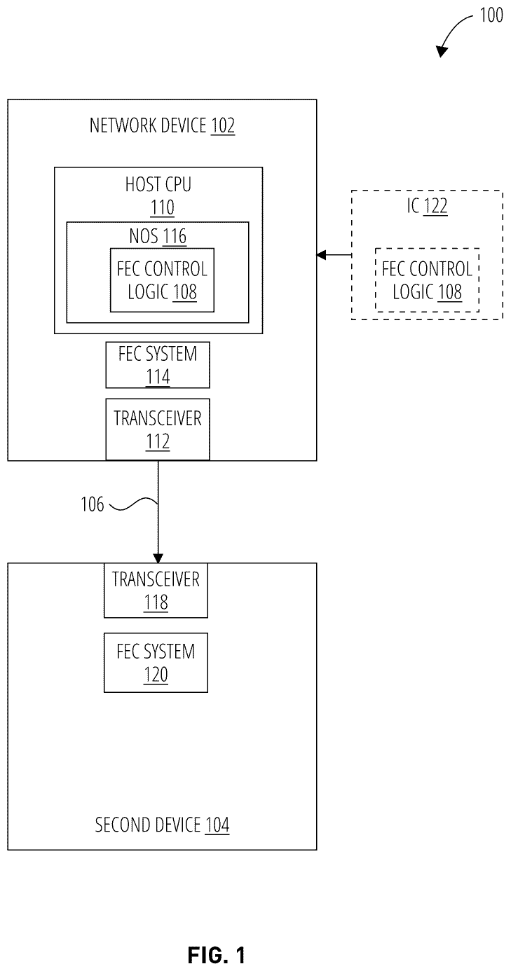

FIG. 1 is a block diagram of a computing system 100 with a network device 102 with an FEC control logic 108 according to at least one embodiment. In at least one embodiment, the network device 102 includes a host CPU 110, a Forward Error Correction (FEC) system 114, and a transceiver 112. In at least one embodiment, the host CPU 110 can execute a network operating system (NOS) 116. In at least one embodiment, the FEC control logic 108 can be integrated into the NOS 116. In at least one embodiment, instead of being integrated into the NOS 116, the FEC control logic 108 can be implemented in a separate integrated circuit (IC) 122.

In at least one embodiment, the FEC control logic 108 can use adaptive FEC that alters the error correction parameters based on ongoing assessments of link quality (e.g., using BER and SNR measurements as strong indicators of link quality. That is, the FEC control logic 108 can use dynamic FEC configurations, instead of static FEC configuration as done conventionally. The FEC control logic 108 can leverage real-time BER and SNR measurements to guide these adjustments within the NOS layer, providing a more responsive and efficient error correction mechanism. The FEC control logic 108 can also leverage real-time BER and SNR measurements to guide these adjustments outside of the NOS layer, such as using a separate IC controller. As described above, BER and SNR are strong indicators of link quality. BER measures the number of bit errors in a transmitted data stream, while SNR assesses the ratio of the signal power to the noise power in a transmission. By continuously monitoring these parameters, the FEC control logic 108 can dynamically adjust the level of FEC redundancy required to maintain data integrity. Rather than relying on machine learning models or other complex computing solutions, which can introduce significant computational overhead, the FEC control logic 108 can utilize a rule-based approach for decision-making. Predefined rules can be established based on extensive empirical data, mapping specific BER and SNR values to corresponding FEC rates. This ensures quick and efficient adjustments with minimal computational load.

The network device 102 can communicate with a second device 104 over a link 106. The second device 104 can include a transceiver 118 and an FEC system 120. The network device 102 can be a router, a switch, a hub, a modem, an access point (AP), a firewall, a gateway, a repeater, a load balancer, a network interface card (NIC), a network adapter, a proxy server, or the like. The second device 104 can be any device in a computing system, such as an endpoint device, an end-user device (e.g., desktop, laptop, smartphone, tablets, television, gaming console, printer, scanner, etc.), a server, a storage device, a web server, an application server, a database server, a device in a cloud computing system, a network-attached storage, a file, an Internet of Things (IoT) devices or smart device (e.g., smart home devices, security cameras, smart locks, smart doorbells, industrial IoT devices such as sensors, automation systems, etc., a point-of-sale (POS) system, a ATM machine, a building management system, a security system, etc. The second device 104 can also be individual components of these types of devices, such as a central processing unit (CPU), a graphics processing unit (GPU), an accelerator, a microcontroller, a radio frequency (RF) integrated circuit, etc.

In at least one embodiment, the FEC control logic 108 are implemented as instructions executed in connection with the NOS 116. The instructions, when executed by the host CPU 110 (or other processing device), causes the network device 102 to perform various operations. The network device 102 can encode first data using an FEC encoder of the FEC system 114. The FEC encoder encodes the first data at a first encoding rate. As described above, the network device 102 is a transmitting device that applies an FEC algorithm in the FEC system 114 to the data before sending it. For example, the FEC system 114 includes an FEC encoder that adds redundant error correction bits (also known as parity or check bits), using mathematical techniques such as Hamming codes, Reed-Solomon codes, or Low-Density Parity-Check (LDPC) codes. These additional bits allow the receiver to identify and fix errors without needing retransmission.

Once encoded, the network device 102 sends the first data to the second device 104 over a link 106 (or other communication channel) between the network device 102 and the second device 104. The link 106 can be over any communication medium, such as wired links, wireless links, fiber optic links, wireless networks, satellite links, or the like. During transmission, the first data is susceptible to various issues such as noise, interference, or packet loss, which can introduce bit errors. Despite these challenges, the added redundancy helps ensure data integrity. In some cases, the link 106 is over a direct connection, a network connection, a connection to a fabric, or the like.

At the receiving end, the second device 104 uses the same FEC algorithm at the FEC system 120 to process the incoming data. The FEC system 120 can include an FEC decoder to decode the encoded first data received over the link. It examines the redundant bits to detect and correct errors, eliminating the need for retransmission. However, if the number of errors exceeds the FEC's correction capability, additional error detection mechanisms like Cyclic Redundancy Check (CRC) may identify the data as corrupted. By implementing this approach, FEC significantly improves data transmission reliability, particularly in environments where retransmissions would be costly or impractical.

In at least one embodiment, the network device 102 can determine a bit error rate (BER) measurement and a signal-to-noise ratio (SNR) measurement associated with the link 106. In at least one embodiment, the FEC control logic 108 can obtain the BER measurement and the SNR measurement from the transceiver 112. In at least one embodiment, the BER measurement of the link 106 can be determined by the FEC system 120 and the SNR measurement can be determined by the transceiver 118. The transceiver 118 can report the BER measurement and the SNR measurement back to the transceiver 112. The transceiver 112 can share the BER measurement and the SNR measurement with the FEC control logic 108. The second device 104 can continue to measure BER and SNR and share those measurements of the link 106 with the network device 102.

In at least one embodiment, the network device 102 determines a second encoding rate using the BER measurement and the SNR measurement. The network device 102 can encode second data using the FEC encoder at the second encoding rate. The network device 102 can send the second data to the second device 104 over the link 106. In at least one embodiment, the FEC control logic 108 determines the second encoding rate and controls the FEC system 114 to encode the second data at the second encoding rate. The network device 102 can continue to obtain the BER and SNR measurements of the link 106 and determine subsequent encoding rates for the FEC system 114 to use. The network device 102 can use hysteresis to avoid switching between encoding rates to frequently or in a manner that impacts performance.

In a further embodiment, the network device 102 can send a notification of a configuration change of the second encoding rate to the second device 104. This can be done to synchronize the FEC systems 114 and 120. There are different ways of achieving FEC synchronization. In at least one embodiment, the network device 102 can send the notification of the configuration change by sending the notification in a protocol header being sent to the second device 104. In at least one embodiment, the protocol header is an Ethernet header. In at least one embodiment, the notification of FEC changes can be sent in various TCP options, such as reserved fields, or extension fields. In at least one embodiment, the notification of FEC changes can be sent in transport headers, data link layer headers. It should also be noted that in addition to, or instead of the notification of the configuration change of the second encoding rate, other encoding parameters can be modified, such as code rate, block length, parity bits, constraint length, FEC type, interleaving depth, modulation and coding scheme (MCS), error threshold, encoding algorithm type, etc. In at least one embodiment, the network device 102 can send the notification of the configuration change by sending the notification in an acknowledgment packet being sent to the second device 104. It should be noted that acknowledgment packet can be any acknowledgment packet being sent by the network device 102 to the second device 104. For example, the notification change can be sent in an acknowledgment packet when the second device 104 sends BER and SNR measurements. In other embodiments, the packet does not have to be an acknowledgment packet, but any management or control packet, or a data packet, so long as the second device 104 can extract the notification from the packet to determine that the network device 102 has a configuration change. In some embodiments, the second device 104 can send an acknowledgment packet back to the network device 102 in response to receiving the notification of the configuration change. In at least one embodiment, the network device 102 can temporarily deactivate the link 106 to signal to the second device 104 about a configuration change. The network device 102 can toggle a port state to restart a negotiation process between the network device 102 and the second device 104. The network device 102 can send the notification of the configuration change of the second encoding rate during the negotiation process. The network device 102 can then re-activate the link 106.

In at least one embodiment, the FEC control logic 108 can cause the FEC system 114 to encode the first data at the first encoding rate and cause the transceiver 112 to send the first data to the second device 104 over the link 106. The FEC control logic 108 can obtain the BER measurement and SNR measurement associated with the link 106, and determine the second encoding rate using the BER measurement and SNR measurement. The FEC control logic 108 can cause the FEC system 114 to encode the second data at the second encoding rate and cause the transceiver 112 to send the second data to the second device 104 over the link 106. It should be noted that the link 106 can be bi-directional. The above description is from the point of view of the network device 102 as the transmitter and the second device 104 as the receiver. Since there is also a reverse path of the second device 104 being the transmitter and the network device 102 as the receiver, there could be a negotiation of the same or a different FEC algorithm in each direction. In at least one embodiment, the link 106 can use the same FEC algorithms across the bi-directional paths. In at least one embodiment, the link 106 can use different FEC algorithms across each of the bi-directional paths. The FEC on each path of the link 106 can be separately negotiated with this approach, whereas in previous static FEC configurations, the FEC algorithm negotiated and used is assumed to be the same in each direction.

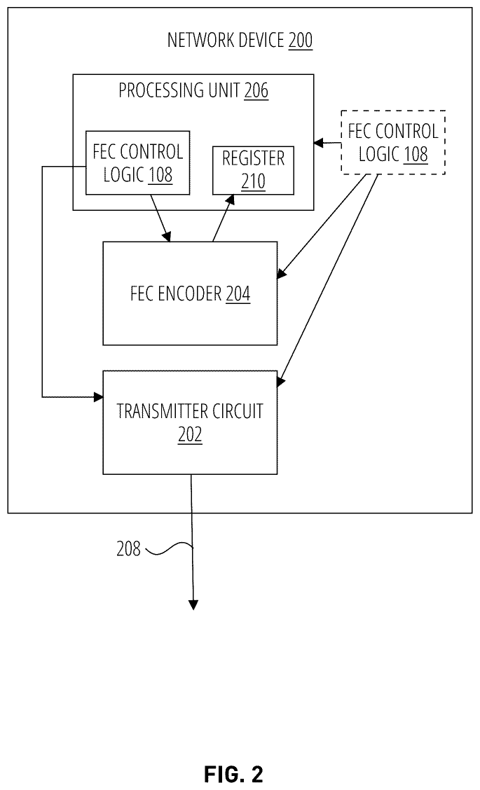

FIG. 2 is a block diagram of a network device 200 with FEC control logic 108 according to at least one embodiment. The network device 200 includes a transmitter circuit 202 (also referred to as transmitter circuitry), an FEC encoder 204, and a processing unit 206.

In at least one embodiment, the FEC control logic 108 is implemented as hardware unit that is coupled to the processing unit 206, the FEC encoder 204, and the transmitter circuit 202. In at least one embodiment, the FEC control logic 108 is implemented as a finite state machine. In at least one embodiment, the hardware FEC control logic 108 is implemented in combinational logic, or the like. In this embodiment, the hardware FEC control logic 108 can cause the FEC encoder 204 to encode first data using a first encoding rate. The hardware FEC control logic 108 can cause the transmitter circuit 202 to transmit the first data over a link 208 to a second device. The hardware FEC control logic 108 can collect one or more BER measurements and one or more SNR measurements associated with the link 208. The hardware FEC control logic 108 can determine a second encoding rate based on the BER measurement and the SNR measurement. The hardware FEC control logic 108 can send a notification of a configuration change of the second encoding rate to the second device. This can be done in various ways as described herein. The hardware FEC control logic 108 can cause the FEC encoder to encode second data using the second encoding rate. The hardware FEC control logic 108 can cause the transmitter circuit 202 to transmit the second data over the link 208 to the second device.

In at least one embodiment, the FEC control logic 108 is implemented as instructions executed by the processing unit 206. For example, instructions of the FEC control logic 108 can be stored in a memory device. The instructions, when executed by the processing unit 206, cause the network device 200 to perform the various operations described herein. In this embodiment, the FEC control logic 108 can perform various operations, including causing the FEC encoder 204 to encode first data using a first encoding rate, causing the transmitter circuit 202 to transmit the first data over the link 208 to the second device, collecting the one or more BER and SNR measurements, determining a second encoding rate based on the one or more BER and SNR measurements, sending a notification of a configuration change of the second encoding rate to the second device, causing the FEC encoder 204 to encode second data using the second encoding rate, and causing the transmitter circuit 202 to transmit the second data over the link 208 to the second device.

In at least one embodiment, the transmitter circuit 202 and the FEC encoder 204 are part of a physical (PHY) layer. In a further embodiment, the processing unit 206 is part of NOS layer. The NOS layer can obtain the one or more BER and SNR measurements from the PHY layer. The FEC control logic 108 can then use the one or more BER and SNR measurements to determine whether to adjust the encoding rate of the FEC encoder 204. In at least one embodiment, the PHY layer can include a receiver circuit and FEC decoder as well.

As described above, when the FEC control logic 108 determines to make a configuration change to the encoding rate, the FEC control logic 108 can notify the second device so that the FEC decoder uses the new encoding rate. This can be done to synchronize the FEC encoder 204 and the FEC decoder on the receiver device. There are different ways of achieving FEC synchronization. In at least one embodiment, the FEC control logic 108 can send a notification of the configuration change by causing the processing unit 206 to send the notification in a protocol header of a packet. In at least one embodiment, the FEC control logic 108 can send the notification of the configuration change by causing the processing unit 206 to send the notification in an acknowledgment packet being sent to the second device. In at least one embodiment, the FEC control logic 108 can cause the processing unit 206 or the transmitter circuit 202 to temporarily deactivate the link 208 to signal to the second device about a configuration change. The FEC control logic 108 can cause the processing unit 206 or the transmitter circuit 202 to toggle a port state to restart a negotiation process between the network device 200 and the second device. During the negotiation process, the processing unit 206 or transmitter circuit 202 can send a notification of the configuration change of the second encoding rate. Once the negotiation process is complete, the processing unit 206 or the transmitter circuit 202 can re-activate the link 208. After the link 208 is re-activated, the FEC encoder 204 can encode subsequent data using the second encoding rate. As described herein, in other embodiments, the FEC control logic 108 can change other FEC parameters and send a notification of any changes to the FEC parameters based on the BER and SNR measurements.

In at least one embodiment, the network device 200 includes a register 210. The register 210 can be part of the processing unit 206. The register 210 can be outside of the processing unit 206. The register 210 is accessible by the FEC encoder 204. The FEC control logic 108 (or processing unit 206) can write a value to the register 210, where the value represents the encoding rate to be used by the FEC encoder 204. For example, the register 210 can store a first value at a first time, and a second value at a second time, the first value indicative of the first encoding rate and the second value indicative of the second encoding rate. The FEC encoder 204 can read the first value or the second value from the register 210. In another embodiment, the register 210 (or one or more registers) store an FEC configuration profile to be used by the FEC encoder 204. The FEC configuration profile can store various FEC parameters that can be modified by the FEC control logic 108 based on the BER and SNR measurements. In at least one embodiment, the FEC parameters can include code rate, block length, parity bits, constraint length, FEC type, interleaving depth, MCS, error threshold, encoding algorithm type, etc.

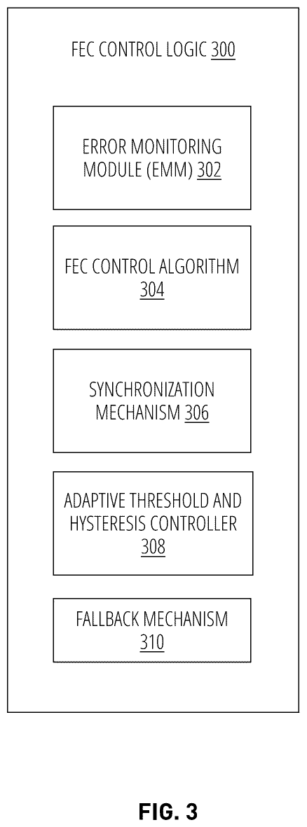

FIG. 3 is a block diagram of FEC control logic 300 according to at least one embodiment. In this embodiment, the FEC control logic 300 includes an Error Monitoring Module (EMM) 302, an FEC control algorithm (FCA) 304, a synchronization mechanism 306, an adaptive threshold and hysteresis controller 308, and a fallback mechanism 310. The FEC control logic 300 can adjust FEC rates at the NOS layer according to real-time BER and SNR data, providing a responsive and bandwidth-efficient approach to error correction. The EMM 302 collects and analyzes real-time BER and SNR measurements, supplying continuous link quality data to the NOS layer. The FCA 304 can be a deterministic, rule-based algorithm. The FCA 304 can determine optimal FEC encoding rates by evaluating the BER and SNR levels against pre-set thresholds, as described in more detail below. This approach enables seamless, efficient adjustments without complex processing. The synchronization mechanism 306 can make synchronized rate adjustments. When link conditions change, the synchronization mechanism 306 can update the FEC rate (FEC configuration) across both communication endpoints, ensuring synchronized error correction. This avoids the desynchronization that could lead to data corruption or packet loss. The adaptive threshold and hysteresis controller 308 can work in connection with the FCA 304 or as part of the FCA 304. The adaptive threshold and hysteresis controller 308 can implement adaptive hysteresis to avoid frequent rate oscillations between FEC adjustments. FEC adjustments only occur for significant, sustained changes in link quality, preventing unnecessary renegotiations and ensuring stable system behavior. The fallback mechanism 310 can work in connection with the FCA 304 or as part of the FCA 304. For cases of extreme link degradation or temporary instability, the fallback mechanism 310 can be used to default to a high-redundancy FEC rate. This fallback setting maintains essential data integrity until conditions improve, allowing seamless re-adjustment when stability returns. It should be noted that although illustrated as separate components, the functionality of these components can be implemented in processing logic comprising hardware, firmware, software, or any combination thereof.

As described above, the FCA 304 can determine optimal FEC encoding rates by evaluating the BER and SNR levels against pre-set thresholds. In at least one embodiment, the FCA 304 can use lookup table (LUT) data to define the pre-set thresholds for the BER and SNR measurements. For example, the LUT data can define a first range of BER measurements and a second range of SNR measurements to define multiple FEC modes with corresponding FEC gains, such as illustrated in the example shown in the following Table:

| | SNR Range | | | FEC Gain | | Latency |
|---|---|---|---|---|---|---|
| BER Range | (dB) | | Recommended FEC mode | (dB) | | Impact |
| BER ≤ 1E−12 | >25 | dB | No FEC (Raw mode) | 0 | dB | Lowest |
| | | | | | | latency |
| 1E−12 ≤ BER ≤ 1E−9 | 22-25 | dB | Firecode FEC (FC-FEC, | 3-6 | dB | Low |
| | | | RS(528,514) | | | latency |
| 1E−9 ≤ BER ≤ 1E−6 | 18-22 | dB | Reed-Solomon FEC | 6-8 | dB | Moderate |
| | | | (RS(544,514) aka KP-FEC) | | | latency |
| 1E−6 ≤ BER ≤ 1E−4 | 14-18 | dB | Reed-Solomon Strong FEC | 8-10 | dB | Higher |
| | | | (RS(544,514) + interleaving) | | | latency |
| BER ≥ 1E−4 | <14 | dB | Soft Decision FEC (SD-FEC, | >10 | dB | Highest |
| | | | Staircase, or Concatenated | | | Latency |
| | | | FEC | | | |

It should be noted that these values are merely exemplary, but can be determined based on empirical data.

In at least one embodiment, the synchronization mechanism 306 can ensure FEC synchronization by embedding FEC configuration updates into existing protocol headers or signaling mechanisms, such as reserved bits in network packets (e.g., Ethernet headers, TCP options). For example, reserved or extension fields in existing transport or data link layer headers can be used to signal FEC changes. In at least one embodiment, the synchronization mechanism 306 can use Ethernet Frame Extensions. In particular, the synchronization mechanism 306 can utilize reserved or vendor-specific fields in Ethernet headers to embed FEC configuration changes. In at least one embodiment, the synchronization mechanism 306 can use the Link Layer Discovery Protocol (LLDP). In particular, LLDP frames can be used by the synchronization mechanism 306 for signaling FEC adjustments. In at least one embodiment, the synchronization mechanism 306 can add the FEC change notifications onto acknowledgment packets. In at least one embodiment, the synchronization mechanism 306 can use a Graceful Shutdown (GSHUT) operation to synchronize the FEC system. In at least one embodiment, the synchronization mechanism 306 can put the link into a GSHUT state before applying dynamic FEC changes, followed by toggling a port state. Toggling the port state could effectively leverage existing Auto-Negotiation (AN) methods for FEC synchronization. In at least one embodiment, the synchronization mechanism 306 can initiate GSHUT, temporarily deactivating the link to signal the link partner that a configuration change (e.g., FEC adjustment) is underway. The synchronization mechanism 306 toggle the port state (down and then up) to restart the Auto-Negotiation process. During this process, the updated FEC settings are advertised and negotiated as per standard AN protocols. Once the common FEC configuration is determined via AN, the link is re-established, ensuring both ends are synchronized.

Changing FEC encoding or decoding at runtime may cause temporary desynchronization, leading to packet loss. In at least one embodiment, this can be mitigated by introducing a transitional FEC mode where both the old and new FEC schemes are recognized for a brief overlap period. During the transitional FEC mode, both endpoints accept packets encoded with either the old or new FEC settings. In another embodiment, this can be mitigated by buffering data temporarily at the sender during the transition, and using a retransmission mechanism to resend lost packets.

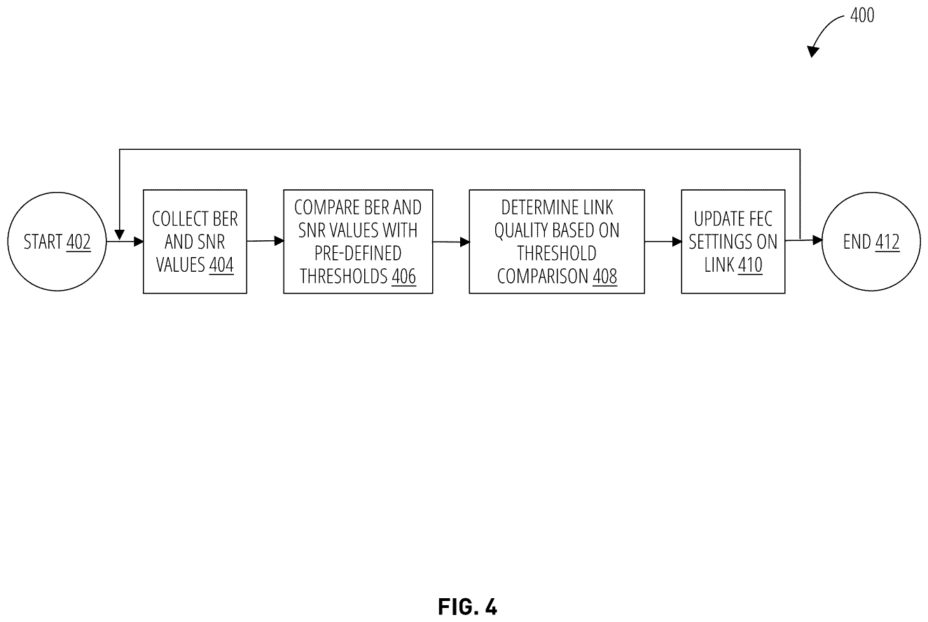

FIG. 4 is a flow diagram of an example process flow 400 for updating FEC setting of a link based on BER and SNR measurements according to at least one embodiment. The process flow 400 can be performed using one or more processing units (e.g., CPUs, GPUs, accelerators, physics processing units (PPUs), data processing units (DPUs), etc.), which may include (or communicate with) one or more memory devices. In at least one embodiment, process flow 400 can be performed using a processing device or processing devices. The process flow 400 may be performed by processing logic that may comprise hardware (e.g., circuitry, dedicated logic, programmable logic, microcode, etc.), software (e.g., instructions run on a processing device to perform hardware simulation), or a combination thereof. In at least one embodiment, process flow 400 can be performed using processing units of network device 102 of FIG. 1, FEC control logic 108 of FIG. 1, host CPU 110 of FIG. 1, or IC 122 of FIG. 1. In at least one embodiment, the process flow 400 can be performed using the network device 200 of FIG. 2, processing unit 206 of FIG. 2, or FEC control logic 108 of FIG. 2. In at least one embodiment, process flow 400 can be performed using processing units of other FEC control logic 300 of FIG. 3. In at least one embodiment, the process flow 400 are operations of the FCA 304 of FIG. 3.

The process flow 400 starts at block 402. At block 404, the process flow 400 collects BER and SNR values. At block 406, the process flow 400 compares BER and SNR values with pre-defined thresholds. At block 408, the process flow 400 determines link quality based on the threshold comparisons. At block 410, the process flow 400 updates FEC settings of the link. The process flow 400 returns to block 404 to continue collecting BER and SNR values, until the process flow 400 ends at block 412.

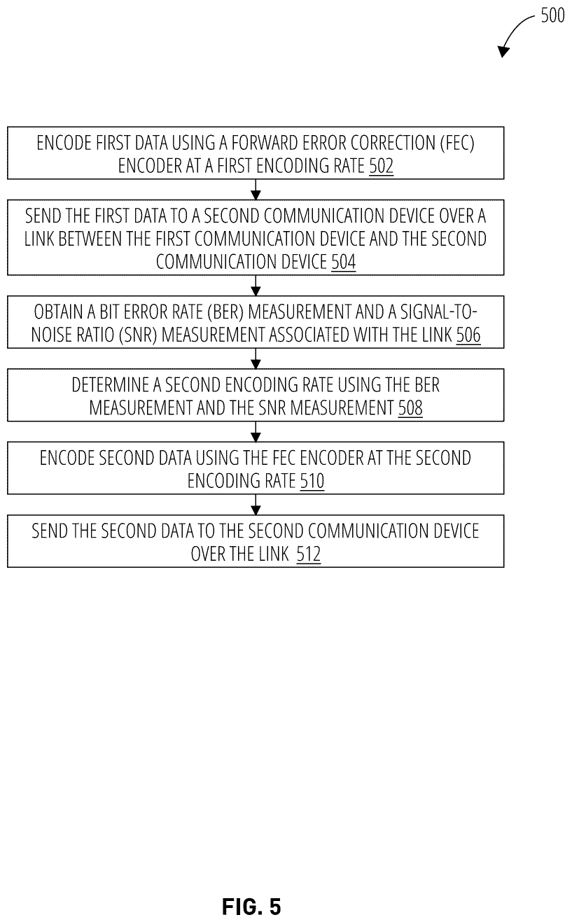

FIG. 5 is a flow diagram of an example method 500 for dynamically adjusting FEC configuration based on BER and SNR measurements according to at least one embodiment. Method 500 can be performed using one or more processing units (e.g., CPUs, GPUs, accelerators, physics processing units (PPUs), data processing units (DPUs), etc.), which may include (or communicate with) one or more memory devices. In at least one embodiment, method 500 can be performed using a processing device or processing devices. The method 500 may be performed by processing logic that may comprise hardware (e.g., circuitry, dedicated logic, programmable logic, microcode, etc.), software (e.g., instructions run on a processing device to perform hardware simulation), or a combination thereof. In at least one embodiment, method 500 can be performed using processing units of network device 102 of FIG. 1, FEC control logic 108 of FIG. 1, host CPU 110 of FIG. 1, or IC 122 of FIG. 1. In at least one embodiment, the method 500 can be performed using the network device 200 of FIG. 2, processing unit 206 of FIG. 2, or FEC control logic 108 of FIG. 2. In at least one embodiment, method 500 can be performed using processing units of other FEC control logic 300 of FIG. 3. In at least one embodiment, the method 500 are operations of the FCA 304 of FIG. 3.

In at least one embodiment, processing units performing the method 500 can be executing instructions stored on a non-transient computer readable storage media. In at least one embodiment, the method 500 can be performed using multiple processing threads (e.g., CPU threads and/or GPU threads), individual threads executing one or more individual functions, methods, subroutines, or operations of the method. In at least one embodiment, processing threads implementing any of method 500 can be synchronized (e.g., using semaphores, critical sections, and/or other thread synchronization mechanisms). Alternatively, processing threads implementing the method 500 can be executed asynchronously with respect to each other. Various operations of method 500 can be performed in a different order compared with the order shown in FIG. 5. Some operations of the method 500 can be performed concurrently with other operations. In at least one embodiment, one or more operations shown in FIG. 5 may not always be performed. The method 500 can be performed by other devices described herein.

Referring to FIG. 5, the method 500 begins with the processing logic encoding first data using an FEC encoder at a first encoding rate (block 502). At block 504, the processing logic sends the first data to a second communication device over a link between the first communication device and the second communication device. At block 506, the processing logic obtains a BER measurement and an SNR measurement associated with the link. At block 508, the processing logic determines a second encoding rate using the BER measurement and the SNR measurement. At block 510, the processing logic encodes second data using the FEC encoder at the second encoding rate. At block 512, the processing logic sends the second data to the second communication device over the link.

In a further embodiment, the processing logic sends a notification of a configuration change of the second encoding rate to the second communication device. In at least one embodiment, the processing logic sends the notification by sending the notification in a protocol header. In at least one embodiment, the processing logic sends the notification by sending the notification in an acknowledgment packet being sent to the second communication device. In at least one embodiment, the processing logic temporarily deactivates the link to signal to the second communication device about a configuration change and toggles a port state to restart a negotiation process between the first communication device and the second communication device. The processing logic sends a notification of the configuration change of the second encoding rate during the negotiation process. The processing logic re-activates the link.

In a further embodiment, the processing logic obtains the BER measurement and SNR measurement by obtaining, using a network operating system (NOS) layer of the first communication device, the BER measurement and the SNR measurement from a PHY layer of the first communication device.

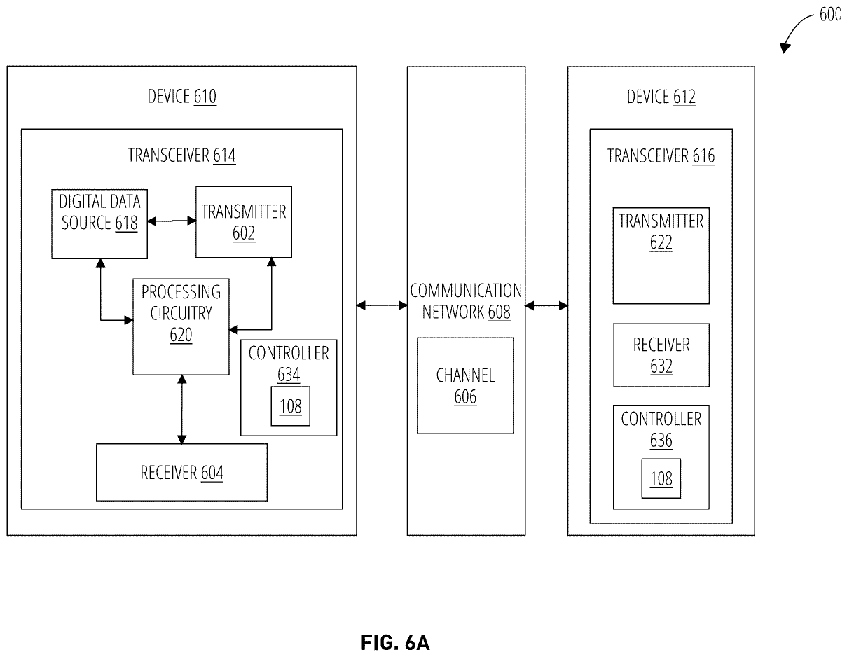

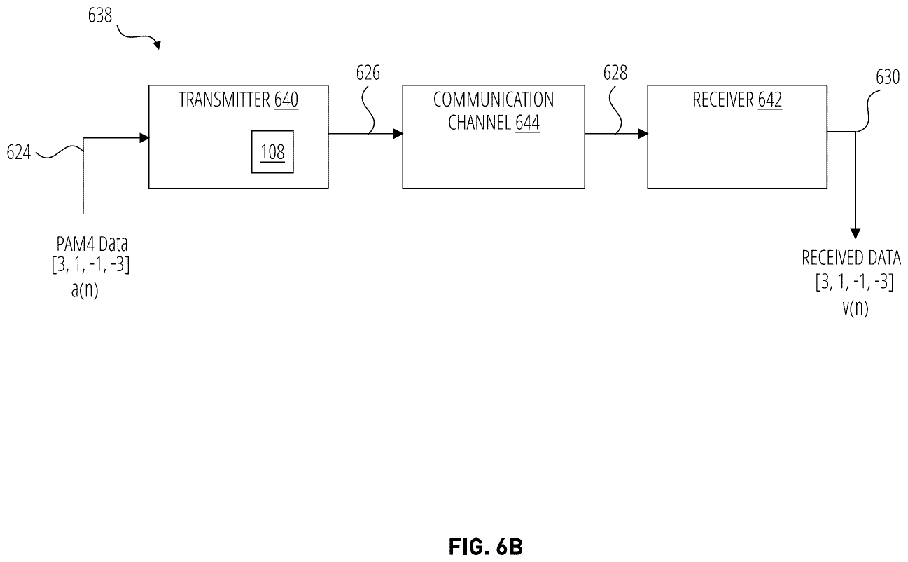

FIG. 6A illustrates an example communication system 600 with a controller 634 for optimizing post-FEC BER performance of an FEC system according to at least one embodiment. The communication system 600 includes a device 610, a communication network 608 including a communication channel 606, and a device 612. In at least one embodiment, the devices 610 and 612 are integrated circuits of a Personal Computer (PC), a laptop, a tablet, a smartphone, a server, a collection of servers, or the like. In some embodiments, the devices 610 and 612 may correspond to any appropriate type of device that communicates with other devices also connected to a common type of communication network 608. According to embodiments, the transmitter 602 and 622 of devices 610 or 612 may correspond to transmitters of a Graphics Processing Unit (GPU), a switch (e.g., a high-speed network switch), a network adapter, a central processing unit (CPU), a data processing unit (DPU), etc.

Examples of the communication network 608 that may be used to connect the devices 610 and 612 include wires, conductive traces, bumps, terminals, optical fibers, or the like. In other embodiments, the communication network 608 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 608 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 608 is a network that enables data transmission between the devices 610 and 612 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller In at least one embodiment, a system for high-speed network communication includes a processing unit, a network interface comprising a receiver or transceiver with controller to optimize post-FEC BER performance of an FEC system using a post-FEC correlated performance metric, as described herein. The processing unit can include a CPU, a GPU, a DPU, a network adapter, a network switch, an NVLink switch, or the like. 2436, as described herein.

Other examples for the communication network 608 can include other chip-to-chip or die-to-die interconnects, such as GRS, LPI (low power interface) or LLI (low latency interface).

The device 610 includes a transceiver 614 for sending and receiving signals, for example, data signals. The data signals may be digital or optical signals modulated with data or other suitable signals for carrying data.

The transceiver 614 may include a digital data source 618, a transmitter 2402, a receiver 604, and processing circuitry 620 that controls the transceiver 614. The digital data source 618 may include suitable hardware and/or software for outputting data in a digital format (e.g., in binary code and/or thermometer code). The digital data output by the digital data source 618 may be retrieved from memory (not illustrated) or generated according to input (e.g., user input). The transceiver 614 can include the controller 634 with FEC control logic 108 as described above with respect to FIG. 1 to FIG. 5.

The transceiver 614 includes suitable software and/or hardware for receiving digital data from the digital data source 618 and outputting data signals according to the digital data for transmission over the communication network 608 to a transceiver 616 of device 612.

The receiver 604 of device 610 may include suitable hardware and/or software for receiving signals, for example, data signals from the communication network 608. For example, the receiver 604 may include components for receiving processing signals to extract the data for storing in a memory. In at least one embodiment, the transceiver 616 includes a transmitter 622 and receive 632. The transceiver 616 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. The transceiver 616 can include the controller 636 with FEC control logic 108 as described above with respect to FIG. 1 to FIG. 5.

The processing circuitry 620 may comprise software, hardware, or a combination thereof. For example, the processing circuitry 620 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 620 may comprise hardware, such as an Application-Specific Integrated circuit (ASIC). Other non-limiting examples of the processing circuitry 620 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 620 may be provided on a Printed Circuit Board (PCB) or collection of PCBs. It should be appreciated that any appropriate type of electrical component or collection of electrical components may be suitable for inclusion in the processing circuitry 620. The processing circuitry 620 may send and/or receive signals to and/or from other elements of the transceiver 614 to control the overall operation of the transceiver 614.

The transceiver 614 or selected elements of the transceiver 614 may take the form of a pluggable card or controller for the device 610. For example, the transceiver 614 or selected elements of the transceiver 614 may be implemented on a network interface card (NIC).

The device 612 may include a transceiver 616 for sending and receiving signals, for example, data signals over a channel 606 of the communication network 608. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 614 may be applied to transceiver 616, and thus, the structure of transceiver 616 is not described separately.

Although not explicitly shown, it should be appreciated that devices 610 and 612 and the transceiver 614 and transceiver 616 may include other processing devices, storage devices, and/or communication interfaces generally associated with computing tasks, such as sending and receiving data.

FIG. 6B illustrates a block diagram of an example communication system 638 employing a receiver 642 with FEC control logic 108 FEC control logic for dynamic FEC optimization according to at least one embodiment. In the example shown in FIG. 6B, a Pulse Amplitude Modulation level-4 (PAM4) modulation scheme is employed with respect to the transmission of a signal (e.g., digitally encoded data) from a transmitter (TX) 640 to a receiver (RX) 642 via a communication channel 644 (e.g., a transmission medium). The communication channel 2406 can be PCIe, NVLink, Ethernet, InfiniBand, GRS, C2C, D2D, or the like. In this example, the transmitter 640 receives an input data 624 (i.e., the input data at time n is represented as “a(n)”), which is modulated in accordance with a modulation scheme (e.g., PAM4) and sends the signal 626 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 644 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 644 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 642 receives an incoming signal 628 over the communication channel 644. The receiver 642 can output a received signal 630, “v(n),” including the set of data symbols (e.g., symbols −3, −1, 1, 3, wherein the symbols represent coded binary data).

In at least one embodiment, the transmitter 640 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 642 can be part of a SerDes IC. The SerDes IC can include a clock-recovery circuit. The clock-recovery circuit can be coupled to an ADC and an equalization block. In another embodiment, the SerDes IC can include additional equalization block before a symbol detector.

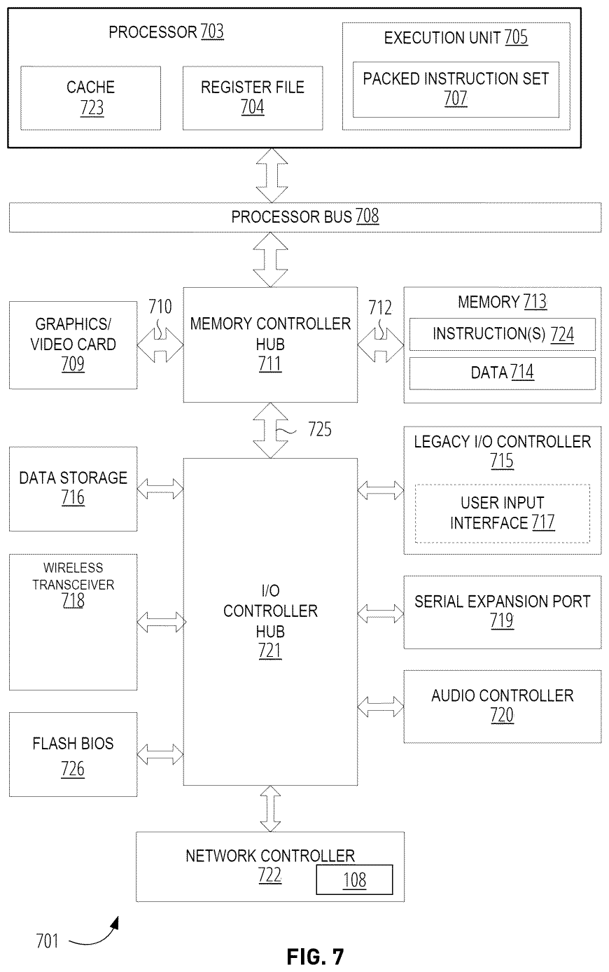

FIG. 7 illustrates an example computer system 701, including FEC control logic 108, in accordance with at least some embodiments. In at least one embodiment, computer system 701 may be a system with interconnected devices and components, an SOC, or some combination. In at least one embodiment, computer system 701 is formed with a processor 703 that may include execution units to execute an instruction. In at least one embodiment, computer system 701 may include, without limitation, a component, such as a processor 703, to employ execution units including logic to perform algorithms for processing data. In at least one embodiment, computer system 701 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 701 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 701 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 701 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 701 may include, without limitation, processor 703 that may include, without limitation, one or more execution units 705 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 701 is a single processor desktop or server system. In at least one embodiment, computer system 701 may be a multiprocessor system. In at least one embodiment, processor 703 may include, without limitation, a CISC microprocessor, a RISC microprocessor, a VLIW microprocessor, and a processor implementing a combination of instruction sets, or any other processor device, such as a digital signal processor, for example. In at least one embodiment, processor 703 may be coupled to a processor bus 708 that may transmit data signals between processor 703 and other components in computer system 701.

In at least one embodiment, processor 703 may include, without limitation, a Level 1 (“L1”) internal cache memory (“cache”) 723. In at least one embodiment, processor 703 may have a single internal cache or multiple levels of internal cache. In at least one embodiment, cache memory may reside external to processor 703. In at least one embodiment, processor 703 may also include a combination of both internal and external caches. In at least one embodiment, a register file 704 may store different types of data in various registers including, without limitation, integer registers, floating point registers, status registers, and instruction pointer register.

In at least one embodiment, execution unit 705, including, without limitation, logic to perform integer and floating point operations, also resides in processor 703. Processor 703 may also include a microcode (“ucode”) read only memory (“ROM”) that stores microcode for certain macro instructions. In at least one embodiment, execution unit 705 may include logic to handle a packed instruction set 707. In at least one embodiment, by including packed instruction set 707 in an instruction set of a general-purpose processor 703, along with associated circuitry to execute instructions, operations used by many multimedia applications may be performed using packed data in a general-purpose processor 703. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 706 may also be used in microcontrollers, embedded processors, graphics devices, DSPs, and other types of logic circuits. In at least one embodiment, computer system 701 may include, without limitation, a memory 713. In at least one embodiment, memory 713 may be implemented as a DRAM device, an SRAM device, flash memory device, or other memory devices. Memory 713 may store instruction(s) 724 and/or data 714 represented by data signals that may be executed by processor 703.

In at least one embodiment, a system logic chip may be coupled to a processor bus 708 and memory 713. In at least one embodiment, the system logic chip may include, without limitation, a memory controller hub (“MCH”) 711, and processor 703 may communicate with MCH 711 via processor bus 708. In at least one embodiment, MCH 711 may provide a high bandwidth memory path 712 to memory 713 for instruction and data storage and for storage of graphics commands, data, and textures. In at least one embodiment, MCH 711 may direct data signals between processor 703, memory 713, and other components in computer system 701 and may bridge data signals between processor bus 708, memory 713, and a system I/O 725. In at least one embodiment, a system logic chip may provide a graphics port for coupling to a graphics controller. In at least one embodiment, MCH 711 may be coupled to memory 713 through high bandwidth memory path 712, and graphics/video card 709 may be coupled to MCH 711 through an Accelerated Graphics Port (“AGP”) interconnect 710.

In at least one embodiment, computer system 701 may use system I/O 725 that is a proprietary hub interface bus to couple MCH 711 to I/O controller hub (“ICH”) 721. In at least one embodiment, ICH 721 may provide direct connections to some I/O devices via a local I/O bus. In at least one embodiment, a local I/O bus may include, without limitation, a high-speed I/O bus for connecting peripherals to memory 713, a chipset, and processor 703. Examples may include, without limitation, an audio controller 720, a firmware hub (“flash BIOS”) 726, a wireless transceiver 718, a data storage 716, a legacy I/O controller 715 containing a user input interface 717, a keyboard interface, a serial expansion port 719, such as a USB, and a network controller 722. In at least one embodiment, the network controller 722 includes the FEC control logic 108 as described herein. Data storage 716 may comprise a hard disk drive, a floppy disk drive, a CD-ROM device, a flash memory device, or other mass storage device.

In at least one embodiment, FIG. 7 illustrates a system, which includes interconnected hardware devices or “chips.” In at least one embodiment, FIG. 7 may illustrate an example SoC. In at least one embodiment, devices illustrated in FIG. 7 may be interconnected with proprietary interconnects, standardized interconnects (e.g., PCIe), or some combination thereof. In at least one embodiment, one or more components of system 702 are interconnected using compute express link (“CXL”) interconnects.

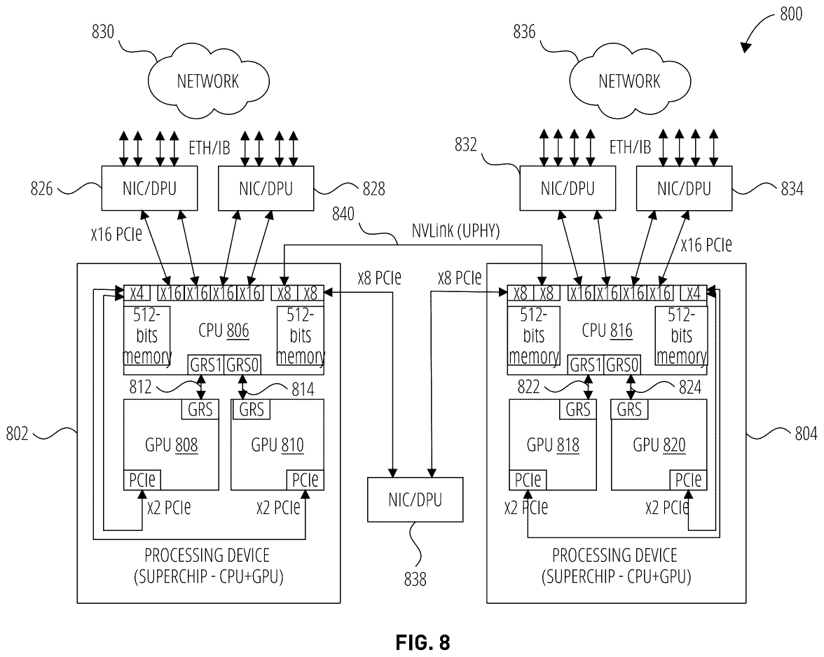

FIG. 8 is a block diagram of a computing system 800 having two processing devices coupled to each other and multiple networks according to at least one embodiment. The computing system 800 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 800. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 800 highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs. An example architecture of a multi-GPU architecture is illustrated in FIG. 8.

As illustrated in FIG. 8, the computing system 800 includes a processing device 802 with a multi-GPU architecture. In particular, the processing device 802 includes a CPU 806, a GPU 808, and a GPU 810. The CPU 806 can be coupled to the GPU 808 via an die-to-die (D2D) or chip-to-chip (C2C) interconnect 812, such as a Ground-Referenced Signaling interconnect (GRS interconnect). The CPU 806 can be coupled to the GPU 810 via a D2D or C2C interconnect 814. The CPU 806 can also couple to the GPU 808 and GPU 810 via PCIe interconnects. The CPU 806 can be coupled to one or more network interface cards (NICs) or data processing units (DPUs), which are coupled to one or more networks. For example, as illustrated in FIG. 8, the CPU 806 is coupled to a first NIC/DPU 826, which is coupled to a network 830. The CPU 806 is also coupled to a second NIC/DPU 828, which is coupled to the network 830. The NIC/DPU 826 and NIC/DPU 828 can be coupled to the network 830 over Ethernet (ETH) or InfiniBand (IB) connections.

The computing system 800 also includes a processing device 804 with a multi-GPU architecture. In particular, the processing device 804 includes a CPU 816, a GPU 818, and a GPU 820. The CPU 816 can be coupled to the GPU 818 via an D2D or C2C interconnect 822. The CPU 816 can be coupled to the GPU 820 via a D2D or C2C interconnect 824. The CPU 816 can also couple to the GPU 818 and GPU 820 via PCIe interconnects. The CPU 816 can be coupled to one or more NICs or DPUs, which are coupled to one or more networks. For example, as illustrated in FIG. 8, the CPU 816 is coupled to a first NIC/DPU 832, which is coupled to a network 836. The CPU 816 is also coupled to a second NIC/DPU 834, which is coupled to the network 836. The NIC/DPU 832 and NIC/DPU 834 can be coupled to the network 836 over Ethernet (ETH) or InfiniBand (IB) connections.

In at least one embodiment, the processing device 802 and the processing device 804 can communication with each other via a NIC/DPU 838, such as over PCIe interconnects. The processing device 802 and processing device 804 can also communicate with each other over a high-bandwidth communication interconnects 840, such as an NVLink interconnect or other high-speed interconnects. The NIC/DPUs of FIG. 8 can be the various embodiments of the DPUs described herein. The FEC control logic 108 can be implemented in any receiver device of any of the devices described herein.

In at least one embodiment, the computing system 800 is used for high-speed network communication and includes a processing unit (e.g., CPU 806, GPU 808, GPU 810, CPU 816, GPU 818, GPU 820, NIC/DPU 826, NIC/DPU 828, NIC/DPU 832, NIC/DPU 834, or NIC/DPU 838), and a network interface coupled to the processing unit. The network interface can include the operations and functionality of the DPUs described herein.

In at least one embodiment, the computing system 800 includes a host device and an auxiliary device. The auxiliary device includes a device memory and a processor, communicably coupled to the device memory. The auxiliary device performs the operations described herein with respect to FIG. 1 to FIG. 7. The auxiliary device can include a GPU. The auxiliary device can include a DPU. The auxiliary device can include a DPU. The auxiliary device can include accelerator hardware.

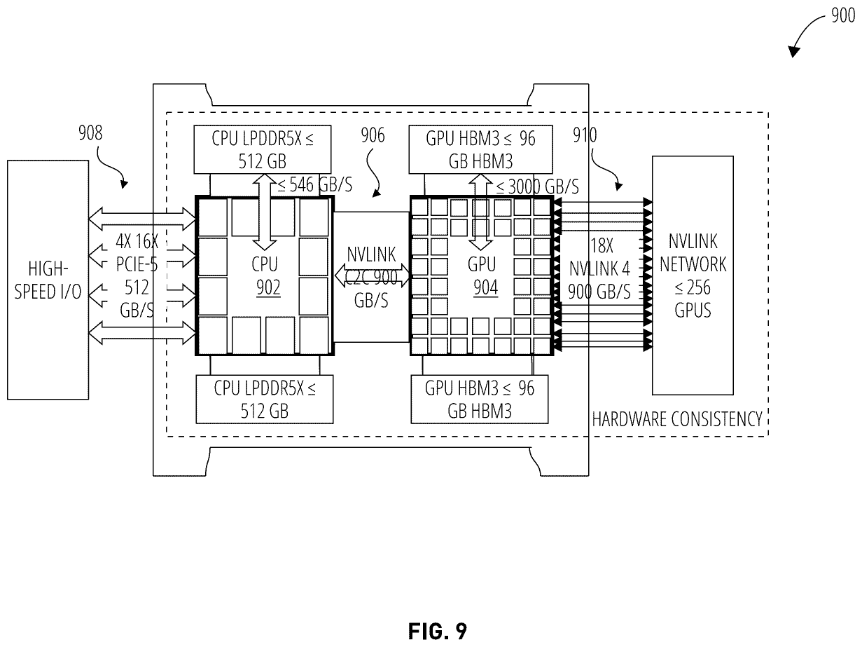

FIG. 9 is a block diagram of a computing system 900 having a CPU 902 and a GPU 904 in a single integrated circuit according to at least one embodiment. The computing system 900 can be a highly integrated design where a CPU 902 and GPU 904 are connected on a single integrated circuit, utilizing an NVLink C2C (Chip-to-Chip) interconnect 906 to enable fast, low-latency communication between the two processing units. This close integration allows for efficient data transfer and parallel processing between the CPU 902 and GPU 904, optimizing performance for complex computational tasks. The GPU elements within the computing system 900 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 910. Additionally, the computing system 900 can be designed to interface with a high-speed I/O through PCIe interconnects 908, ensuring rapid data transfer to and from external devices, further enhancing the system's capabilities in handling data-intensive tasks and providing robust connectivity to peripheral components. It should be noted that the C2C interconnects 906 can be considered D2D interconnects since the CPU 902 and the GPU 904 are located on the same integrated circuit. The integrated circuit can include CPU memory (also referred to as main memory) and GPU memory, which are accessible by the CPU 902 and the GPU 904, respectively, over high-speed interconnects. The computing system 900 can bring together performance of the GPU 904 with the versatility of the CPU 902. The CPU 902 can be connected with a high-bandwidth and memory coherent C2C interconnects 906 in a single integrated circuit. The computing system 900 can support a link switch system.

The computing system 900 can include the FEC control logic 108 used for the various embodiments described herein with respect to FIG. 1 to FIG. 8. The FEC control logic 108 can be implemented in any transmitter device of any of the devices described herein.

In at least one embodiment, the computing system 900 is used for high-speed network communication and includes a processing unit, and a network interface coupled to the processing unit. The network interface can include the operations and functionality of the DPUs described herein.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 8. The auxiliary device can include a GPU. The auxiliary device can include a DPU. The auxiliary device can include a DPU. The auxiliary device can include accelerator hardware.

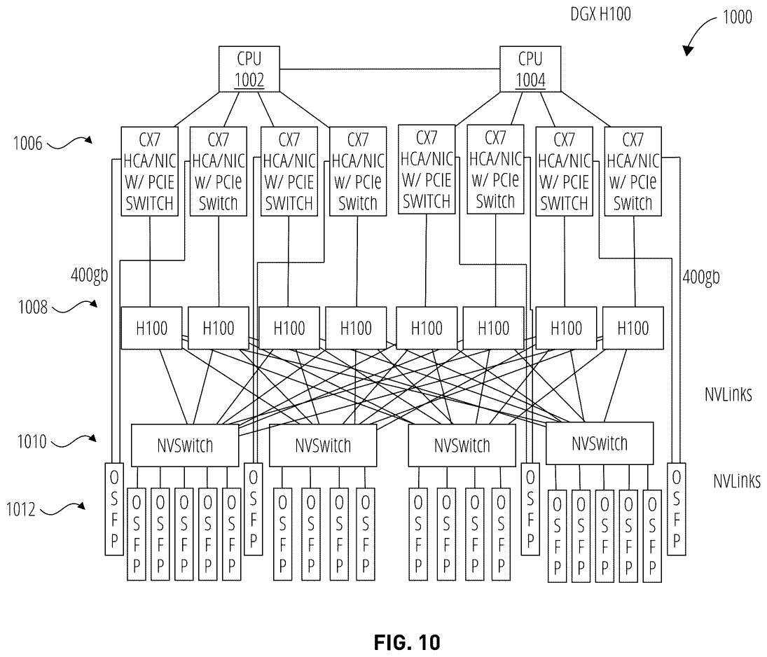

FIG. 10 is a block diagram of a computing system 1000 having tensor core GPUs 1008 according to at least one embodiment. The computing system 1000 can be a DGX H100 system, which is a high-performance computing platform designed to meet the demands of AI, ML, and deep learning (DL) workloads. The computing system 1000 can include multiple tensor core GPUs 1008 (e.g., NVIDIA H100 Tensor Core GPUs). The tensor core GPUs 1008 can each be one of the integrated circuits described above with respect to FIG. 8 to FIG. 9. The tensor core GPUs 1008 can be optimized for AI/ML/DL applications, offering exceptional performance for deep learning training, inference, and high-performance computing tasks. The tensor core GPUs 1008 within the computing system 1000 are interconnected using high-speed communication interfaces like NVLinks, enabling rapid data transfer between them, which is crucial for handling large-scale AI models and datasets with low latency. This computing system 1000 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1008, the computing system 1000 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1008 for their specific applications. The computing system 1000 is ideally suited for large-scale AI model training, real-time inference, scientific simulations, data analytics, and other compute-intensive tasks that require massive parallel processing power.

The tensor core GPUs 1008 can be coupled to multiple CPUs, such as CPU 1002 and CPU 1004, using switches 1006 (e.g., CX7 HCA/NIC with PCIe switch). The tensor core GPUs 1008 can be coupled to each other via switches 1010 (e.g., NVSwitches). The switches 1006 and switches 1010 can be coupled to high-speed transceiver modules 1012. The high-speed transceiver modules 1012 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1000 remains capable of meeting increasing data demands and can be upgraded to support future advancements in network speeds, thus contributing to the system's overall performance and scalability.

In at least one embodiment, the computing system 1000 can be considered a data-network configuration with full-bandwidth intra-server NVLinks. In this example, all eight tensor core GPUs 1008 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1008 can half-subscribe eighteen NVLinks to GPUs in other servers. Four tensor core GPUs 1008 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1008 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1000 can include the various embodiments of the FEC control logic 108 described herein with respect to FIG. 1 to FIG. 9.

In at least one embodiment, the computing system 1000 is used for high-speed network communication and includes a processing unit (e.g., CPU 1002, CPU 1004, switches 1006, tensor core GPUs 1008, switches 1010, high-speed transceiver modules 1012), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1000 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors—for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A first communication device comprising:
a processing device; and
a memory device to store instructions that when executed by the processing device cause the first communication device to perform operations comprising:
encoding first data using a Forward Error Correction (FEC) encoder at a first encoding rate;
sending the first data to a second communication device over a link between the first communication device and the second communication device;
obtaining a bit error rate (BER) measurement and a signal-to-noise ratio (SNR) measurement associated with the link;
determining a second encoding rate using the BER measurement and the SNR measurement;
encoding second data using the FEC encoder at the second encoding rate; and
sending the second data to the second communication device over the link.

2. The first communication device of claim 1, wherein the operations further comprises sending a notification of a configuration change of the second encoding rate to the second communication device.

3. The first communication device of claim 2, wherein sending the notification comprises sending the notification in a protocol header being sent to the second communication device.

4. The first communication device of claim 2, wherein sending the notification comprises sending the notification in an acknowledgment packet being sent to the second communication device.

5. The first communication device of claim 1, wherein the operations further comprises:
temporarily deactivating the link to signal to the second communication device about a configuration change;
toggling a port state to restart a negotiation process between the first communication device and the second communication device;
sending a notification of the configuration change of the second encoding rate during the negotiation process; and
re-activating the link.

6. The first communication device of claim 1, further comprising a physical (PHY) layer comprising a transmitter circuit and the FEC encoder, and wherein obtaining the BER measurement and SNR measurement comprises obtaining the BER measurement and the SNR measurement from the PHY layer.

7. The first communication device of claim 6, further comprising a central processing unit (CPU) to execute a network operating system, wherein the first communication device is a network device, wherein obtaining the BER measurement and the SNR measurement and determining the second encoding rate are performed by the network operating system.

8. The first communication device of claim 1, further comprising:
a central processing unit (CPU), the CPU to execute a network operating system, wherein the first communication device is a network device; and
an integrated circuit coupled to the CPU, the integrated circuit comprising the processing device and the memory device.

9. The first communication device of claim 1, further comprising a register to store a first value at a first time and a second value at a second time, the first value indicative of the first encoding rate and the second value indicative of the second encoding rate, wherein the FEC encoder is to read the first value or the second value from the register.

10. A method of operating a first communication device, the method comprising:
encoding first data using a Forward Error Correction (FEC) encoder at a first encoding rate;
sending the first data to a second communication device over a link between the first communication device and the second communication device;
obtaining a bit error rate (BER) measurement and a signal-to-noise ratio (SNR) measurement associated with the link;
determining a second encoding rate using the BER measurement and the SNR measurement;
encoding second data using the FEC encoder at the second encoding rate; and
sending the second data to the second communication device over the link.

11. The method of claim 10, further comprising sending a notification of a configuration change of the second encoding rate to the second communication device.

12. The method of claim 11, wherein sending the notification comprises sending the notification in a protocol header.

13. The method of claim 11, wherein sending the notification comprises sending the notification in an acknowledgment packet being sent to the second communication device.

14. The method of claim 10, further comprising:
temporarily deactivating the link to signal to the second communication device about a configuration change;
toggling a port state to restart a negotiation process between the first communication device and the second communication device;
sending a notification of the configuration change of the second encoding rate during the negotiation process; and
re-activating the link.

15. The method of claim 10, wherein obtaining the BER measurement and SNR measurement comprises obtaining, using a network operating system (NOS) layer of the first communication device, the BER measurement and the SNR measurement from a physical (PHY) layer of the first communication device.

16. A network device comprising:
a transmitter circuit;
a Forward Error Correction (FEC) encoder; and
a processing unit coupled to the FE and the transmitter circuit, the processing unit to:
cause the FEC encoder to encode first data using a first encoding rate;
cause the transmitter circuit to transmit the first data over a link to a second device;
collect a bit error rate (BER) measurement and a signal-to-noise ratio (SNR) measurement associated with the link;
determine a second encoding rate based on the BER measurement and the SNR measurement;
send a notification of a configuration change of the second encoding rate to the second device;
cause the FEC encoder to encode second data using the second encoding rate; and
cause the transmitter circuit to transmit the second data over the link to the second device.

17. The network device of claim 16, wherein, to send the notification, the processing unit is to send the notification in a protocol header.

18. The network device of claim 16, wherein, to send the notification, the processing unit is to send the notification in an acknowledgment packet being sent to the second device.

19. The network device of claim 16, wherein, to send the notification, the processing unit is to:
temporarily deactivate the link to signal to the second device about a configuration change;
toggle a port state to restart a negotiation process between the network device and the second device;
send a notification of the configuration change of the second encoding rate during the negotiation process; and
re-activate the link.

20. The network device of claim 16, wherein the transmitter circuit and the FEC encoder are part of a physical (PHY) layer, and the processing unit is part of a network operating system (NOS) layer, wherein the NOS layer is to obtain the BER measurement and SNR measurement from the PHY layer.

21. A system for high-speed network communication, the system comprising:
a processing unit; and
a network device coupled to the processing unit, wherein the network device comprises:
a processing device; and
a memory device to store instructions that when executed by the processing device cause the network device to perform operations comprising:
encoding first data using a Forward Error Correction (FEC) encoder at a first encoding rate;
sending the first data to a second device over a link between the network device and the second device;
obtaining a bit error rate (BER) measurement and a signal-to-noise ratio (SNR) measurement associated with the link;
determining a second encoding rate using the BER measurement and the SNR measurement;
sending a notification of a configuration change of the second encoding rate to the second device;
encoding second data using the FEC encoder at the second encoding rate; and
sending the second data to the second device over the link.

22. The network device of claim 21, wherein the network device further comprises:
a physical (PHY) layer comprising a transmitter circuit and the FEC encoder, and wherein the processing device is part of a network operating system (NOS) layer, wherein the NOS layer is to obtain the BER measurement and SNR measurement from the PHY layer.
